(19) United States
(12) Patent Application Publication
(10) Pub. No.: US 2024/0265578 A1
(43) Pub. Date: Aug. 8, 2024

(54) APPARATUS AND METHOD FOR PERFORMING PIXEL CALIBRATION WITH HIGH ACCURACY

(71) Applicant: AUROS Technology, Inc., Hwaseong-si (KR)

(72) Inventors: Young Je WOO, Hwaseong-si (KR); Chang Ho LEE, Hwaseong-si (KR); Hyun Jin CHANG, Hwaseong-si (KR)

(21) Appl. No.: 18/413,006

(22) Filed: Jan. 15, 2024

(30) Foreign Application Priority Data
Feb. 2, 2023 (KR) 10-2023-0014380

(51) Int. Cl. G06T 7/80; G06T 7/11; G06T 7/12; G06T 7/579; G06T 7/60

(52) U.S. Cl. CPC G06T 7/80; G06T 7/11; G06T 7/12; G06T 7/579; G06T 7/60; G06T 2207/20021; G06T 2207/30204

(57) ABSTRACT

A calibration apparatus is provided. The calibration apparatus includes: an acquisition unit for acquiring a captured image from a capturing device that captures a specified region in which a plurality of markers are indicated; and an analysis unit for finding the physical size of each pixel in the captured image through the analysis of physical movement data of at least one of the specified region and the capturing device and the captured image.

### CROSS-REFERENCE TO RELATED APPLICATION

This application claims priority to and the benefit of Korean Patent Application No. 10-2023-0014380 filed in the Korean Intellectual Property Office on Feb. 2, 2023, the entire contents of which are incorporated herein by reference.

### TECHNICAL FIELD

The present disclosure relates to an apparatus and method for calibrating the physical size of pixels in an image.

### BACKGROUND

By measuring the physical distance (size, horizontal length, vertical length, diagonal length, diameter, etc.) of a pixel through pixel calibration, the measured value of the pixel may be converted into units of length such as meters when measuring overlays.

Conventionally, the physical size of each pixel is found by capturing a target whose physical distance can be measured by a camera and measuring how many pixels are present within the target.

However, the conventional method has problems such as low measurement accuracy and low reproducibility.

### SUMMARY

In view of the above, the present disclosure provides a calibration apparatus and method that accurately analyze and calibrate the size of a pixel in a captured image of a target.

A calibration apparatus according to one or more embodiments of the present disclosure may include an acquiror to acquire a captured image from a capturing device that captures a specified region including a plurality of markers; and an analyzer to determine a physical size of each pixel in the captured image through an analysis of physical movement data of at least one of the specified region and the capturing device and the captured image.

A calibration method according to one or more embodiments of the present disclosure may include acquiring a captured image from a capturing device for capturing a specified region including a plurality of markers; determining a pixel distance corresponding to the number of pixels present between a first marker and a second marker of the plurality of markers, determining a coordinate distance corresponding to a physical distance between the first marker and the second marker by using physical movement data from the first marker to the second marker of the moving object; and analyzing a physical size of each pixel by using the pixel distance and the coordinate distance.

A calibration apparatus according to one or more embodiments of the present disclosure may include at least one memory comprising instructions and at least one hardware processor to execute the instructions within the at least one memory to implement: acquiring a captured image from a capturing device for capturing a specified region including a plurality of markers; determining a pixel distance corresponding to the number of pixels present between a first marker and a second marker of the plurality of markers; determining a coordinate distance corresponding to a physical distance between the first marker and the second marker by using physical movement data from the first marker to the second marker of a moving object; analyzing a physical size of each pixel by using the pixel distance and the coordinate distance.

A calibration apparatus according to one or more embodiments of the present disclosure may operate differently from a method using preset values, such as the actual size of a marker marked on a test board and the actual distance between markers.

In other words, pixel size can be easily calculated by finding the number of pixels included within a marker of a given size and dividing the size of the marker by the number of pixels.

When capturing a small object such as a wafer, an optical magnifying glass or the like is additionally required, and the addition of the optical magnifying glass or the like may lead to distortion of an image to be measured. As a result, although the size of a marker included in a captured image does not change physically, it may be deformed in the image.

Since pixel sizes are processed in images, the physical size of a preset marker, the distance between markers, etc. are hard to apply because of the aforementioned reasons. This is because of low measurement accuracy and low reproducibility (replicability) in the case of a small object.

A calibration apparatus and method according to the present disclosure may suggest another approach for accurately analyzing, setting, and calibrating pixel sizes.

According to one or more embodiments of the present disclosure, a plurality of markers may be provided, and the distance between markers may be physically measured. For example, a calibration apparatus according to the present disclosure may move a capturing device or a specified region to be captured by the capturing device in such a way that a particular point on a marker, i.e., the center, is positioned at the center of a captured image. The specified region may include a chuck or test bed where a wafer is mounted, or may include a test board mounted on a chuck or test bed. When the specified region is moved, this may denote a chuck or test bed where a wafer or test board is mounted.

In one or more embodiments, the calibration apparatus may define the distance the moving object has moved as the position coordinates of that marker. The calibration apparatus may define and set position coordinates for each marker and calculate the distance between two markers by using the position coordinates.

According to one or more embodiments of the present disclosure, the position coordinates set for each marker may be values that are actually measured at the present time. Moreover, according to one or more embodiments of the present disclosure, the number of pixels present between each marker also may be values that are actually measured through the analysis of the captured image.

Consequently, according to one or more embodiments of the present disclosure, even if the distance between each marker is changed due to damage to or distortion of the test board or the like, the physical distance between two markers and the number of pixels between the two markers may be accurately measured by actual measurement regardless of the environment they are in. This makes it possible to accurately find the physical size of each pixel.

In addition, according to one or more embodiments of the present disclosure, a plurality of markers may be formed in the specified region, and a plurality of physical pixel sizes may be acquired by using the plurality of markers. The calibration apparatus according to the present disclosure may analyze, set, and calibrate an average value of the plurality of acquired physical pixel sizes as a physical pixel size for the current captured image. As such, physical pixel sizes can be accurately acquired with robustness even in a noise environment such as in a captured image.

### BRIEF DESCRIPTION OF THE DRAWINGS

FIG. 1 is a schematic diagram showing a calibration apparatus according to an embodiment of the present disclosure.

FIG. 2A and FIG. 2B are schematic diagrams showing an analysis system according to a comparative example.

FIG. 3 is a schematic diagram showing an image captured by a capturing device according to an embodiment of the present disclosure.

FIG. 4 is a schematic diagram showing an encoder according to an embodiment of the present disclosure.

FIG. 5 is a schematic diagram showing an operation of a pixel unit according to an embodiment of the present disclosure.

FIG. 6 is a schematic diagram showing a test board according to an embodiment of the present disclosure.

FIG. 7 is a table showing pixel coordinates and position coordinates of markers according to an embodiment of the present disclosure.

FIG. 8 is a schematic diagram showing distortion of a captured image according to an embodiment of the present disclosure.

FIG. 9 is a flowchart showing a calibration method according to an embodiment of the present disclosure.

FIG. 10 is a diagram showing a computing apparatus according to an embodiment of the present disclosure.

### DETAILED DESCRIPTION

In the following, exemplary embodiments of the present disclosure will be described in detail, with reference to the accompanying drawings, so that a person with ordinary skill in the art to which the present invention pertains may practice them. However, the present disclosure may be implemented in various different forms, and is not limited to the exemplary embodiments described herein. Further, in order to clearly describe the present disclosure in the drawings, the parts which are not related to the description are omitted, and like parts are given like reference numerals, throughout the specification.

In the present specification, redundant description of the same constituent elements will be omitted.

In addition, in the present specification, when a component is described as being “connected” to another component, it should be understood that the component may be directly connected to the other component or other components may be present therebetween. In contrast, in the present specification, when a component is described as being “directly connected” to another component, it should be understood that no other component exists therebetween.

In addition, in the present specification, the expressions “find”, “determine”, “detect”, and “ascertain” may be used interchangeably. In addition, the expressions “found”, “determined”, “detected”, and “ascertained” may be used interchangeably.

In addition, in the present specification, the expressions “step” and “operation” may be used interchangeably.

Furthermore, the terms used in the present disclosure are only for describing specific embodiments, and are not intended to limit the present disclosure.

In the present specification, expressions in the singular form may include the meaning of the plural form unless they clearly mean otherwise in the context.

In the present specification, expressions such as “include” or “have” are only for indicating the existence of a feature, number, step, operation, component, part, or combination thereof described in the present disclosure, and are not intended to exclude in advance the existence or the possibility of the addition of one or more other features, numbers, steps, operations, components, parts, or combinations thereof.

In the present specification, the expression “and/or” means a combination of a plurality of listed items or any one of the plurality of listed items. In the present disclosure, “A or B” means “A,” “B,” or “both A and B.”

In the present specification, detailed descriptions of well-known functions and features that may obscure the gist of the present disclosure will not be provided.

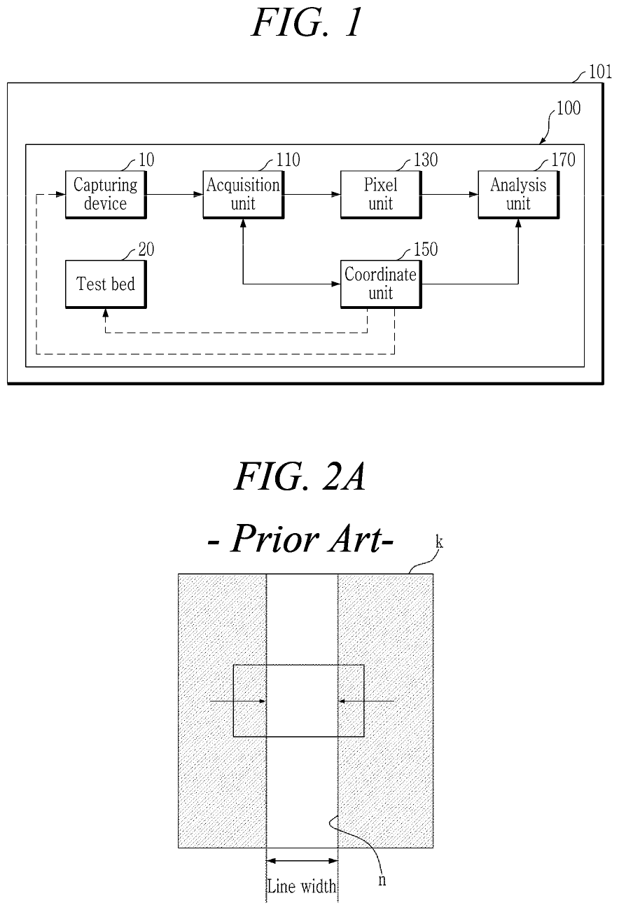

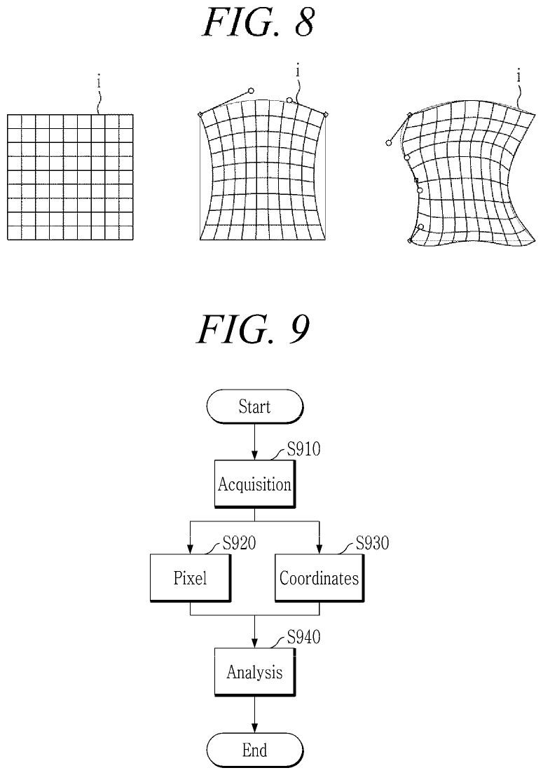

FIG. 1 is a schematic diagram showing a calibration apparatus 100 according to an embodiment of the present disclosure. FIG. 7 is a table showing pixel coordinates and position coordinates of markers according to an embodiment of the present disclosure. FIG. 8 is a schematic diagram showing distortion of a captured image according to an embodiment of the present disclosure.

The calibration apparatus 100 depicted in FIG. 1 may include an acquisition unit (acquiror) 110, a pixel unit (pixel device) 130, a coordinate unit (coordinator) 150, and an analysis unit (analyzer) 170.

The acquisition unit 110 may acquire a captured image from a capturing device 10 for capturing a specified region in which a plurality of markers are indicated. The acquisition unit 110 may be provided with a communication module (communicator) for communicating with the capturing device 10 with wires or wirelessly to acquire the captured image from the capturing device 10.

The analysis unit 170 may find (determine, detect, or ascertain) the physical size of each pixel in a captured image through the analysis of the captured image and physical movement data of at least one of the specified region and the capturing device.

For example, the number of pixels present from a particular marker such as a first marker to another marker such as a second marker may be found (determined, detected, or ascertained) through the analysis of the captured image. A particular marker disposed at an aiming point on the captured image may be taken as a starting point, and the capturing device 10 or the specified region may be moved in such a way that another marker is positioned at this aiming point. In this example, the linear distance that the capturing device 10 or the specified region is moved may correspond to an actual physical distance between the particular marker and the another marker. Once the number of pixels present between the particular marker and the another marker and the actual physical distance between the two markers are determined, the physical size of each pixel may be determined by dividing the actual physical distance by the number of pixels.

Each marker may be formed in the shape of a closed curve that is larger in size than a pixel containing a plurality of subpixels, for example, in the shape of a square.

The analysis unit 170 uses actual measurements of the distance between markers, unlike the conventional method in which marker size is used.

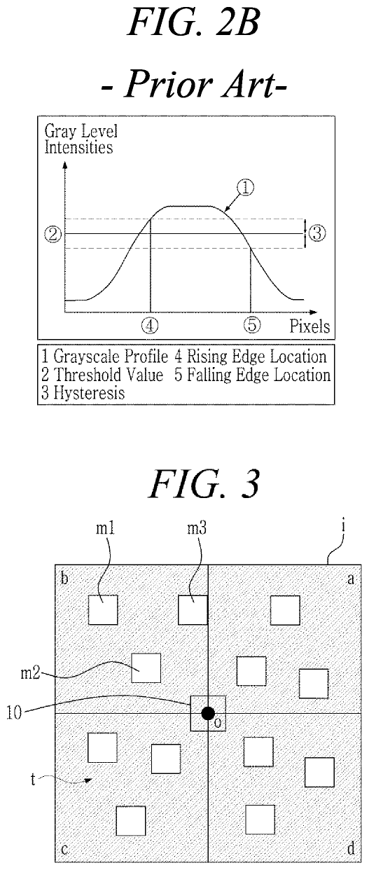

FIG. 2A and FIG. 2B are schematic diagrams showing an analysis system according to a comparative example.

In the analysis system according to the comparative example shown in FIGS. 2A and 2B, a figure or line n having a given line width may be captured. An image k of the captured line n may be as shown in FIG. 2A.

The line width is a predetermined value, and the number of pixels included within the line width may be easily found through the analysis of the image k. Afterwards, the physical size of each pixel may be derived by dividing the line width by the number of pixels.

In order to improve accuracy in the comparative example, an edge of a line needs to be accurately detected. However, it is difficult to accurately locate the edge of a line on the image k, unlike in the real world. To overcome this problem, an edge detection method using gray levels is used, as shown in FIG. 2B.

In this edge detection method, minimum (Min) and maximum (Max) may be obtained at gray level \textcircled{1}, and a relative threshold position \textcircled{2} may be recognized as an edge by using hysteresis \textcircled{3} in which a rising edge location \textcircled{4} and a falling edge location \textcircled{5} are used as upper and lower limits, respectively.

However, there still remains the problem that it is practically impossible to determine (detect or ascertain) an accurate value of the line width. Another limitation is low reproducibility which ranges from 1/20 (1 pixel divided by 20) to 1/10 (1 pixel divided by 10) subpixels. Thus, the comparative embodiment is hardly applicable to such fields as wafer testing in which subpixels as small as 1/10,000 of a pixel need to be considered.

In addition, other issues to put into consideration include distortion of the captured image, FOV (field of view) position, and deformation of a test board which is an object that provides a display region where a plurality of markers are indicated.

To solve these issues, the calibration apparatus 100 may take actual measurements of various necessary data at the time of calibrating the physical size of each pixel.

The pixel unit 130 and the coordinate unit 150 may be used to provide various actual measurements to the analysis unit 170.

The number of pixels present between markers is defined as a pixel distance, and the physical distance between the markers is defined as a coordinate distance.

The pixel unit 130 may determine a pixel distance corresponding to the number of pixels present between the first and second markers which are selected from among a plurality of markers. The pixel unit 130 may determine a pixel distance down to subpixels as small as 1/10,000 of a pixel.

The pixel unit 130, which divides a single pixel into a plurality of subpixels, may use the number of pixels to express the decimals in numerical values of the pixel coordinates as shown in FIG. 7. For example, “Target” in FIG. 7 may represent the identification number of a marker. The table shows that the marker corresponding to Target 1 has a pixel distance of 320 pixels on the x axis from a reference position, and the marker corresponding to Target 2 has a pixel distance of 120.1235 pixels on the x axis from the reference position.

The coordinate unit 150 may determine a coordinate distance corresponding to the physical distance between the first marker and the second marker, by using physical movement data from the first marker to the second marker, for example, the distance moved on the x axis and the distance moved on the y axis. The coordinate unit 150 may determine the coordinate distance by using subpixels as small as 1/10,000 of a pixel.

The analysis unit 170 may determine, analyze, set, and calibrate physical pixel sizes by using pixel distance and coordinate distance. As explained previously, the analysis 170 may determine the physical size of each pixel through an operation in which the coordinate distance between the first marker and the second marker is divided by the pixel distance.

FIG. 3 is a schematic diagram showing an image captured by the capturing device 10.

A captured image i may be a captured image of a specified region t in which a plurality of markers m1, m2, m3, . . . are indicated.

The pixel unit 130 may count the number of pixels (including subpixels) present from a reference position o in the captured image i to a particular marker included in the captured image i. Also, the pixel unit 130 may express the position of the particular marker with respect to the reference position o as pixel coordinates corresponding to the number of pixels present between the reference position o and the particular marker.

The pixel unit 130 may determine a pixel distance corresponding to the number of pixels present between the first and second markers by using the pixel coordinates of each marker.

For example, assuming that the pixel coordinates of the first marker are (230.6351, 250.8354) and the pixel coordinates of the second marker are (120.1235, 136.3154), the difference (110.5116, 114.5200) between the two sets of coordinates may correspond to the pixel distance between the first marker and the second marker.

The analysis unit 170 may determine the physical size of each pixel by using the pixel distance.

The coordinate unit 150 may determine the position coordinates of each marker with respect to the capturing device 10.

The coordinate unit 150 may determine a coordinate distance corresponding to the physical distance between the first marker and the second marker by using the position coordinates of each marker.

The analysis unit 170 may determine the physical size of each pixel by using the coordinate distance.

The analysis unit 170 may determine the physical size of each pixel by using the pixel distance and the coordinate distance.

A length measuring machine such as an encoder may be used to assign position coordinates to a marker included in the captured image i.

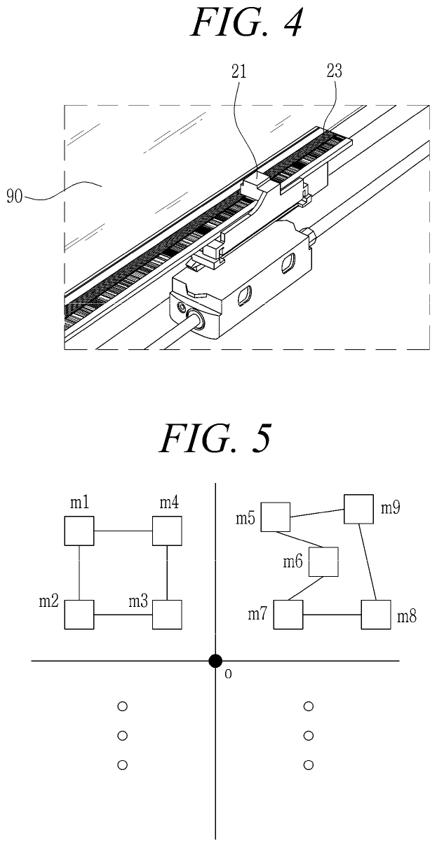

FIG. 4 is a schematic diagram showing an encoder.

For example, the coordinate unit 150 may move at least one moving object 90, which is selected between the capturing device 10 and the specified region t. In this example, the specified region t may include a chuck or test bed 20 that can be moved by the coordinate unit 150. When the captured image i is formed parallel to a virtual xy plane, the moving object 90 may be moved by an xy robot in the x-axis direction or the y-axis direction.

The encoder may measure the length or distance the moving object 90 is moved by the xy robot in the x-axis direction or the length or distance the moving object 90 is moved by the xy robot in the y-axis direction. For example, the encoder may include a scale 23 formed along the x axis or the y axis and a scanner 21 for reading the scale 23. Either the scale 23 or the scanner 21 may be fixed, and the other one may be connected to the moving object 90. When the scale 23 or scanner 21 connected to the moving object 90 moves, the distance the moving object 90 is moved in the x axis direction or the y axis direction may be found.

As an example, FIG. 4 shows a test bed corresponding to the moving object 90. At this time, the scale 23 may be fixedly installed on the test bed.

As another example, the encoder may measure the number of rotations of a motor that moves the moving object 90. Once the distance the moving object 90 moves per rotation of the motor is known, the moving distance of the moving object 90 can be found by using the number of rotations of the motor.

The coordinate unit 150 may obtain an image captured by the capturing device 10 in real time.

The coordinate unit 150 may determine a target corresponding to an image of a particular marker through the analysis of the captured image obtained in real time at a current position of the moving object 90.

Based on the analysis of the captured image, the coordinate unit 150 may move the moving object 90 from a particular position as a starting point so that a particular point on the target is positioned at the center of the captured image. The particular point on the target may vary, including a center point of the target and a vertex of the target. Advantageously, the particular point may be set to a subpixel size. In this example, the position coordinates may be determined at least in units of subpixels.

When the particular point on the target is positioned at the center o of the captured image i by moving the moving object 90 from the particular position as the starting point, this state is defined as a “matching state”. In general, the center o of the captured image i may match the position of the capturing device 10.

The coordinate unit 150 may determine the linear distance, i.e., shortest distance, the moving object 90 has moved from the particular position, until the matching state is reached based on the analysis of the captured image i.

The coordinate unit 150 may set the position coordinates of the particular marker by using the linear distance the moving object 90 has moved from the particular position. For example, if the matching state is reached when the moving object 90 at the particular position has moved 10 mm on the x axis and 5 mm on the y axis, the position coordinates of the particular marker may be set to (10 mm, 5 mm).

According to the above method, the coordinate unit 150 may move the moving object 90 in such a way that the first marker m1 is positioned at the center o of the captured image i.

The coordinate unit 150 may set the coordinates of the moving object 90, which is measured when the first marker m1 is positioned at the center o of the captured image i, as first position coordinates of the first marker m1.

The coordinate unit 150 may move the moving object 90 in such a way that the second marker m2 is positioned at the center o of the captured image i.

The coordinate unit 150 may set the coordinates of the moving object 90, which is measured when the second marker m2 is positioned at the center o of the captured image i, as second position coordinates of the second marker m2.

The coordinate unit 150 may determine the difference between the first position coordinates and the second position coordinates as a coordinate distance corresponding to the physical distance between the first marker and the second marker. The coordinate unit 150 may provide the determined coordinate distance to the analysis unit 170. The analysis unit 170 may determine the physical size of each pixel by using the coordinate distance.

The coordinate unit 150 may set position coordinates for a plurality of markers in the following manner.

As explained previously, when the captured image i is formed parallel to an xy plane formed by the x axis and the y axis, the coordinate unit 150 may move the moving object 90 at an initial position in such a way that a particular marker is positioned at the center of the captured image i. The coordinate unit 150 may set the x-axis distance and y-axis distance the moving object 90 has moved from the initial position to the particular marker as the position coordinates of the particular marker.

Afterwards, in order to set the position coordinates of another marker, the coordinate unit 150 may return the moving object 90 positioned at the particular marker to its initial position, and set the position coordinates of another marker by using the above method over again. However, it may be advantageous that the moving object 90 positioned at the particular marker is moved immediately to another marker for the sake of fast processing.

In other words, once the position coordinates of the particular marker are set, the coordinate unit 150 may move the moving object 90 positioned at the particular marker in such a way that another marker is positioned at the center of the captured image.

The coordinate unit 150 may set the position coordinates of the another marker by adding the values of the x-axis distance and y-axis distance the moving object has moved from the particular marker to the another marker to the position coordinates of the particular marker.

In this manner, the coordinate unit 150 may set position information for each of the plurality of markers.

The coordinate unit 150 may determine a coordinate distance corresponding to the difference between the position coordinates of the first marker m1 and the position coordinates of the second marker m2, the first and second markers m1 and m2 being selected from among the plurality of markers.

The analysis unit 170 may determine the physical size of each pixel present between the first marker m1 and the second marker m2 by using the coordinate distance between the first marker m1 and the second marker m2.

The pixel unit 130 may determine a pixel distance for each of the plurality of markers included in the specified region t. Thus, there may be a plurality of pixel distances.

The coordinate unit 150 may determine a coordinate distance for each of the plurality of markers included in the specified region t. Thus, there may be a plurality of coordinate distances.

The analysis unit 170 may first calculate a plurality of first sizes corresponding to the physical sizes of pixels between each marker, by using a plurality of found pixel distances and a plurality of found coordinate distances.

The analysis unit 170 then may calculate an average value of the plurality of calculated first sizes.

The analysis unit 170 may determine the average value of the first sizes as a second size corresponding to the physical size of pixels in the entire captured image i. The analysis unit 170 may calibrate the physical size of each pixel to the second size.

For example, the analysis unit 170 may form a plurality of groups consisting of pairs of two markers.

In this example, another rule may apply, which requires each marker to be only included in two groups to provide a chain structure grouping.

The analysis unit 170 may first calculate first sizes corresponding to the physical sizes of pixels between two markers forming each group by using the pixel distance and the coordinate distance. The analysis unit 170 may then calculate an average value of the plurality of calculated first sizes. The analysis unit 170 may output the average value of the calculated first sizes as a second size corresponding to the physical size of pixels in the entire captured image. The second size may vary depending on how markers are paired. Thus, it is desirable that markers are paired or grouped in such a way that the accuracy of the second size is improved.

FIG. 5 is a schematic diagram showing an operation of the pixel unit 130.

For example, from a mechanical perspective, various length deviations or tolerances tend to accumulate as a moving object moves farther and farther. Advantageously, markers that are arranged as close to each other as possible may form a group to minimize errors resulting from them.

The grouping may be performed by the pixel unit 130 which determines markers through the analysis of the captured image.

The pixel unit 130 may pair up a first marker m1 with a second marker m2, which is the closest to the first marker m1 among the plurality of markers, through the analysis of the captured image.

The pixel unit 130 may determine a first pixel distance corresponding to the number of pixels present between the paired first and second markers.

The coordinate unit 150 may determine a first coordinate distance corresponding to the physical distance between the first marker and the second marker.

The analysis unit 170 may determine the physical size of each pixel between the first marker and the second marker by using the first pixel distance and the first coordinate distance.

According to the foregoing embodiment, markers closest to each other may form a group. Since it would be advantageous to determine as many first sizes as possible in order to improve the accuracy of the second size, chain-shaped grouping may be desirable.

To form a chain-shaped group, the pixel unit 130 may pair the second marker with a third marker, which is the closest to the second marker among the plurality of markers in the captured image, except the first marker.

The pixel unit 130 may determine a second pixel distance corresponding to the number of pixels present between the paired second and third markers.

The coordinate unit 150 may determine a second coordinate distance corresponding to the physical distance between the second marker and the third marker.

The analysis unit 170 may determine the physical size of each pixel between the second marker and the third marker by using the second pixel distance and the second coordinate distance.

In this example, due to distortion or the like, the physical size of each pixel in a first range between the first marker and the second marker and the physical size of each pixel in a second range between the second marker and the third marker may be different.

The analysis unit 170 may calculate an average value of the physical size of each pixel between the first marker and the second marker and the physical size of each pixel between the second marker and the third marker. The analysis unit 170 may analyze and calibrate the physical size of each pixel in the captured image i by using the average value.

By applying the same method to the other markers including the third marker, a fourth marker, a fifth marker, . . . , the physical size of each pixel may be calculated for all of the plurality of markers included in the specified region, and an average value of the physical sizes may be derived as a physical pixel size for the captured image i.

In the grouping process, another marker closest to a particular marker may be already included in two other groups. In this example, the particular marker has to form a group with a marker positioned farther than the another marker. There may be provided a method for preventing grouping of markers positioned farther away from each other than they are allowed and calculating the physical size of each pixel equally in the entire captured image.

For example, the pixel unit 130 may divide the captured image i into a plurality of segments of equal area.

The pixel unit 130 may determine a pixel distance only for markers within the same segment.

The coordinate unit 150 may determine a coordinate distance only for markers within the same segment.

The analysis unit 170 may calculate the physical size of pixels for each of the segments by using the pixel distance and the coordinate distance.

The analysis unit 170 may calculate an average value of the physical sizes of pixels calculated for all segments.

The analysis unit 170 may output the average value as a physical pixel size for the entire captured image.

For example, three markers may be included in a particular segment. In this example, the analysis unit 170 may calculate a pixel size (first average value) for the entire particular segment by taking the average of pixel sizes between the three markers included in the particular segment. Then, the analysis unit 170 may take the average of first average values for all segments. The analysis unit 170 may output the second average (second average value) of first average values as a physical pixel size for the entire captured image.

The pixel unit 130 may form four or more segments with respect to the captured image i.

In this example, the analysis unit 170 may compare the physical sizes (first average values) of pixels in all the segments, exclude the segments with the largest value and the smallest value, and calculate a second average value by using the first average values for the other segments.

When dividing the captured image i into four segments, the pixel unit 130 may divide the captured image i into four segments by using two virtual line segments orthogonal to each other that intersect at the center o of the captured image i.

The pixel unit 130 may group the markers included in the same segment into pairs along a clockwise or counterclockwise direction. For example, in FIG. 5, four markers m1, m2, m3, and m4 may be provided on the second quadrant, and the first marker m1 may be paired with the second marker m2 along the counterclockwise direction. The second marker m2 may be paired with the third marker m3, and the third marker m3 may be paired with the fourth marker m4. The fourth marker m4 may be paired with the first marker m1. In FIG. 5, a fifth marker m5, a sixth marker m6, a seventh marker m7, an eighth marker m8, and a ninth marker m9 may be arranged on the first quadrant along the counterclockwise direction, and they may be grouped in a similar manner to the first marker, etc.

The analysis unit 170 may calculate the physical size of pixels for each of the segments by using the pixel distance and coordinate distance between each pair of two markers. The analysis unit 170 may calculate an average value of the physical sizes of pixels calculated for all the segments.

The analysis unit 170 may output the average value as a physical pixel size for the entire captured image and perform calibration. The captured image may be post-processed through calibration, and the size of pixels included in the captured image may be an output value of the analysis unit 170.

The calibration apparatus 100 may include a test board having a special structure to improve the accuracy of an average value calculated by using a plurality of markers.

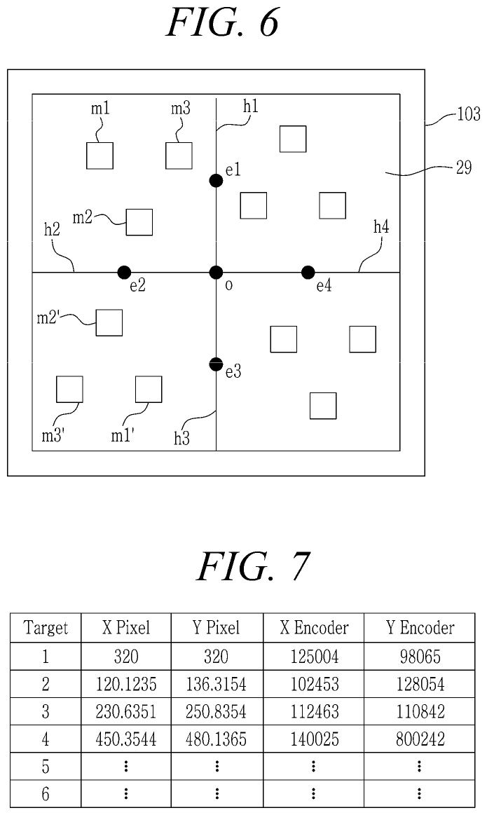

FIG. 6 is a schematic diagram showing a test board.

The test board 29 may be provided on a separate target device 103 that can be mechanically separated from the calibration apparatus 100.

The test board may have a specified region t in which a plurality of markers are indicated.

The test board may divide the specified region into four segments by using two virtual line segments orthogonal to each other that intersect at the center point.

The same number of markers may be formed in each segment of the test board.

A plurality of markers disposed in each segment of the test board may be arranged at positions where they are symmetrical with respect to center points e1, e2, e3, and e4 of the virtual line segments h1, h2, h3, and h4 serving as boundaries between neighboring segments.

Using the above test board, the pixel unit 130 may easily divide the specified region into four segments. Also, since each segment has the same number of markers that correspond to those in a neighboring segment, the reliability and accuracy of the physical size of pixels in the entire captured image i can be improved.

The above-described calibration apparatus 100 may be applied to an overlay device 101.

The overlay device may check whether an alignment error occurs between formed patterns when circuit patterns are laminated on a wafer.

For example, the calibration apparatus of the present disclosure may be applied to calibration of the overlay device before overlay measurement.

FIG. 9 is a flowchart showing a calibration method according to the present disclosure.

The calibration method in FIG. 9 may be performed by the calibration apparatus 100 depicted in FIG. 1.

The calibration method may include an acquisition step S910, a pixel step S920, a coordinate step S930, and an analysis step S940.

In the acquisition step S910, a captured image may be acquired from a capturing device 10 for capturing a specified region where a plurality of markers are indicated. The acquisition step S910 may be performed by the acquisition unit 110.

In the pixel step S920, a pixel distance corresponding to the number of pixels present between a first marker and a second marker may be determined. The pixel step S920 may be performed by the pixel unit 130.

In the coordinate step S930, a coordinate distance corresponding to the physical distance between the first marker and the second marker may be determined by using physical movement data from the first marker to the second marker. The coordinate step S930 may be performed by the coordinate unit 150.

In the analysis step S940, the physical size of each pixel may be determined by using the pixel distance and the coordinate distance. The analysis step S940 may be performed by the analysis unit 170.

The calibration method of the present disclosure allows for determining the physical size of each pixel by using actual measurements of coordinate distance and pixel distance at the time of calibrating the physical size of each pixel. As such, the accuracy of the physical size of each pixel can be greatly improved, and a precision down to subpixels as small as 1/10,000 of a pixel can be achieved.

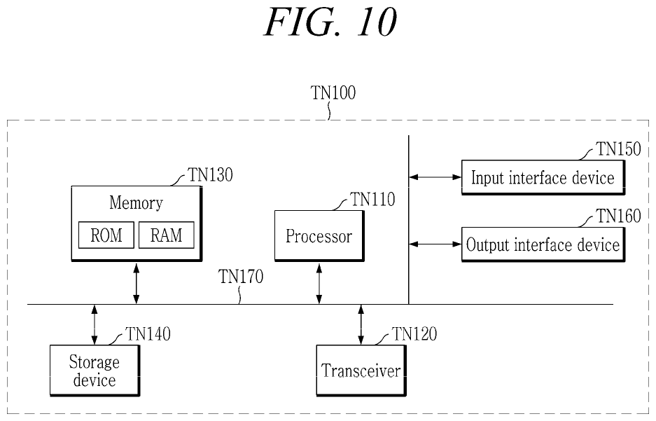

FIG. 10 is a diagram showing a computing apparatus according to an embodiment of the present disclosure. The computing apparatus TN100 of FIG. 10 may be an apparatus (e.g., calibration apparatus 100 or the like) described in the present specification.

In an embodiment shown in FIG. 10, the computing apparatus TN100 may include at least one processor TN110, a transceiver TN120, and a memory TN130. In addition, the computing apparatus TN100 may further include a storage device TN140, an input interface device TN150, and an output interface device TN160. The components included in the computing apparatus TN100 may be connected by a bus TN170 to communicate with each other.

The processor TN110 may execute a program command stored in at least one of the memory TN130 and the storage device TN140 and/or computer readable instructions stored in at one of the memory TN130 and the storage device TN140. An example of the processor TN110 is one or more of a central processing unit (CPU), a graphics processing unit (GPU), or a dedicated processor on which methods according to an embodiment of the present disclosure are performed. The processor TN110 may be configured to implement procedures, functions, and methods described in connection with an embodiment of the present disclosure. The processor TN110 may control each component of the computing apparatus TN100.

Each of the memory TN130 and the storage device TN140 may store various information related to the operation of the processor TN110. Each of the memory TN130 and the storage device TN140 may be configured as at least one of a volatile storage medium and a nonvolatile storage medium. For example, the memory TN130 may be configured as at least one of a read-only memory (ROM) and a random access memory (RAM).

The transceiver TN120 may transmit or receive a wired signal or a wireless signal. The transceiver TN120 may be connected to a network to perform communication.

One or more embodiments of the present disclosure are not implemented only through the apparatus and/or method described so far, and may also be implemented through a program for realizing the function corresponding to the configuration of one or more embodiments of the present disclosure or a recording medium in which the program is recorded, and the implementation may be easily achieved by those skilled in the art to which the present disclosure pertains from the description of the above-described embodiment. The program may include a plurality of instructions, which may be executed by computer hardware.

Although one or more embodiments of the present disclosure have been described above in detail, the scope of the present disclosure is not limited thereto, and various modifications and improvements by those skilled in the art using the basic concept of the present disclosure defined by the appended claims also belong to the scope of the present disclosure.

### Detailed Description of Main Elements

| | |
|---|---|
| 10: Capturing device | 20: Test bed |
| 110: Calibration apparatus | 110: Acquisition unit |
| 130: Pixel unit | 150: Coordinate unit |
| 170: Analysis unit | |

What is claimed is:

1. A calibration apparatus comprising:
an acquiror to acquire a captured image from a capturing device that captures a specified region including a plurality of markers; and
an analyzer to determine a physical size of each pixel in the captured image through an analysis of the captured image and_physical movement data of at least one of the specified region and the capturing device.

2. The calibration apparatus of claim 1, further comprising:
a pixel device to determine a pixel distance corresponding to the number of pixels present between a first marker and a second marker of the plurality of markers, and
a coordinator to determine a coordinate distance corresponding to a physical distance between the first marker and the second marker by using the physical movement data from the first marker to the second marker,
wherein the analyzer determines the physical size of each pixel by using the pixel distance and the coordinate distance.

3. The calibration apparatus of claim 1, further comprising a pixel device to count a number of pixels present from a reference position in the captured image,
wherein the pixel device expresses a position of a first marker with respect to the reference position as pixel coordinates corresponding to the number of pixels present between the first marker and the reference marker, and the pixel device expresses a position of the second marker with respect to the reference position as pixel coordinates corresponding to the number of pixels present between the second marker and the reference marker,
wherein the pixel device determines a pixel distance corresponding to the number of pixels present between the first marker and the second marker by using the pixel coordinates of the first marker and the second marker, and
wherein the analyzer determines the physical size of each pixel by using the pixel distance.

4. The calibration apparatus of claim 3, wherein the pixel device divides a single pixel into a plurality of subpixels, and the pixel device uses the number of pixels to express decimals in numerical values of the pixel coordinates.

5. The calibration apparatus of claim 1, further comprising a coordinator to move at least one moving object, which is selected between the capturing device and the specified region,
wherein the coordinator obtains the captured image captured by the capturing device in real time,
wherein the coordinator determines a target corresponding to an image of a first marker of the plurality of markers through the analysis of the captured image obtained in real time at a current position of the moving object,
wherein based on the analysis of the captured image, the coordinator moves the moving object from a particular position as a starting point so that a particular point on the target is positioned at a center of the captured image,
wherein when the particular point on the target is positioned at the center of the captured image by moving the moving object from the particular position as the starting point, this state is defined as a “matching state”,
wherein the coordinator determines a linear distance the moving object has moved from the particular position, until the matching state is reached based on the analysis of the captured image,
wherein the coordinator sets the position coordinates of the particular marker by using the linear distance the moving object has moved from the particular position,
wherein the coordinator determines a coordinate distance between the first marker of the plurality of markers and a second marker of the plurality of markers, and
wherein the analyzer determines the physical size of each pixel by using the coordinate distance.

6. The calibration apparatus of claim 1, further comprising a coordinator to move at least one moving object, which is selected between the capturing device and the specified region,
wherein the coordinator moves the moving object in such a way that a first marker of the plurality of markers is positioned at a center of the captured image,
wherein the coordinator sets the coordinates of the moving object, which is measured when the first marker is positioned at the center of the captured image, as first position coordinates of the first marker,
wherein the coordinator moves the moving object in such a way that a second marker of the plurality of markers is positioned at the center of the captured image,
wherein the coordinator sets the coordinates of the moving object, which is measured when the second marker is positioned at the center of the captured image, as second position coordinates of the second marker,
wherein the coordinator determines the difference between the first position coordinates and the second position coordinates as a coordinate distance corresponding to the physical distance between the first marker and the second mark, and
wherein the analyzer determines the physical size of each pixel by using the coordinate distance.

7. The calibration apparatus of claim 1, further comprises a coordinator to move at least one moving object, which is selected between the capturing device and the specified region,
wherein, when the captured image is formed parallel to an xy plane formed by the x axis and the y axis, the coordinator moves the moving object at an initial position in such a way that a first marker of the plurality of markers is positioned at the center of the captured image,
wherein the coordinator sets the x-axis distance and y-axis distance the moving object has moved from the initial position to the first marker as the position coordinates of the first marker,
wherein once the position coordinates of the first marker are set, the coordinator moves the moving object positioned at the first marker in such a way that a second marker of the plurality of markers is positioned at the center of the captured image,
wherein the coordinator sets the position coordinates of the second marker by adding the values of the x-axis distance and y-axis distance the moving object has moved from the first marker to the second marker to the position coordinates of the first marker,
wherein the coordinator sets position information for each of the plurality of markers,
wherein the coordinator determines a coordinate distance corresponding to the difference between the position coordinates of the first marker and the position coordinates of the second marker, and
wherein the analyzer determines the physical size of each pixel present between the first marker and the second marker by using the coordinate distance between the first marker and the second marker.

8. The calibration apparatus of claim 1, wherein the number of pixels present between markers is defined as a pixel distance, the physical distance between the markers is defined as a coordinate distance, and the calibration apparatus further comprises:
a pixel device to determine the pixel distance for each of the plurality of markers included in the specified region, and
a coordinator to determine a coordinate distance for each of the plurality of markers included in the specified region,
wherein the analyzer first calculates a plurality of first sizes corresponding to the physical sizes of pixels between each marker, by using a plurality of determined pixel distances and a plurality of determined coordinate distances,
wherein the analyzer calculates an average value of the plurality of calculated first sizes, and
wherein the analyzer determines the average value of the first sizes as a second size corresponding to the physical size of pixels in the entire captured image.

9. The calibration apparatus of claim 1, wherein:
the number of pixels present between markers is defined as a pixel distance,
the physical distance between the markers is defined as a coordinate distance,
the analyzer forms a plurality of groups comprising pairs of two markers,
the analyzer first calculates first sizes corresponding to the physical sizes of pixels between two markers forming each group by using the pixel distance and the coordinate distance,
the analyzer then calculates an average value of the plurality of calculated first sizes, and
the analyzer outputs the average value of the calculated first sizes as a second size corresponding to the physical size of pixels in the entire captured image.

10. The calibration apparatus of claim 1, further comprising a pixel device to determine the plurality of markers through the analysis of the captured image,
wherein the pixel device pairs up a first marker with a second marker, which is the closest to the first marker among the plurality of markers, through the analysis of the captured image,
the pixel device determines a first pixel distance corresponding to the number of pixels present between the paired first and second markers,
the coordinator determines a first coordinate distance corresponding to the physical distance between the first marker and the second marker, and
the analyzer determines the physical size of each pixel between the first marker and the second marker by using the first pixel distance and the first coordinate distance.

11. The calibration apparatus of claim 10, wherein the pixel device pairs the second marker with a third marker, which is the closest to the second marker among the plurality of markers in the captured image, except the first marker,
the pixel device determines a second pixel distance corresponding to the number of pixels present between the paired second and third markers,
the coordinator determines a second coordinate distance corresponding to the physical distance between the second marker and the third marker,
the analyzer determines the physical size of each pixel between the second marker and the third marker by using the second pixel distance and the second coordinate distance,
the analyzer calculates an average value of the physical size of each pixel between the first marker and the second marker and the physical size of each pixel between the second marker and the third marker, and
the analyzer determines the physical size of each pixel in the captured image by using the average value.

12. The calibration apparatus of claim 1, further comprising a pixel device to determine the markers through the analysis of the captured image,
wherein the pixel device divides the captured image into a plurality of segments of equal area,
the pixel device determines a pixel distance only for markers within the same segment.
the coordinator determines a coordinate distance only for the markers within the same segment,
the analyzer calculates the physical size of pixels for each of the segments by using the pixel distance and the coordinate distance,
the analyzer calculates an average value of the physical sizes of pixels calculated for all the segments, and
the analyzer outputs the average value as a physical pixel size for the entire captured image.

13. The calibration apparatus of claim 1, further comprising a pixel device to determine the markers through the analysis of the captured image,
wherein the pixel device divides the captured image into four segments by using two virtual line segments orthogonal to each other that intersect at the center of the captured image,
the pixel device groups the markers included in the same segment into pairs along a clockwise or counterclockwise direction,
the analyzer calculates the physical size of pixels for each of the segments by using the pixel distance and coordinate distance between each pair of two markers,
the analyzer calculates an average value of the physical sizes of pixels calculated for all the segments, and
the analyzer outputs the average value as a physical pixel size for the entire captured image.

14. An overlay device to which the calibration apparatus of claim 1 is applied.

15. A target device to which the calibration apparatus of claim 1 is applied, wherein:
the calibration apparatus further comprises a test board having the specified region,
the test board divides the specified region into four segments by using two virtual line segments orthogonal to each other that intersect at a center point of the specified region,
the same number of markers of the plurality of markers are formed in each segment of the test board, and
the same number of markers formed in each segment of the test board are arranged at positions where the same number of markers are symmetrical with respect to center points of the virtual line segments serving as boundaries between neighboring segments.

16. A calibration method performed by a calibration apparatus, comprising:
acquiring a captured image from a capturing device for capturing a specified region including a plurality of markers;
determining a pixel distance corresponding to the number of pixels present between a first marker and a second marker of the plurality of markers,
determining a coordinate distance corresponding to a physical distance between the first marker and the second marker by using physical movement data from the first marker to the second marker of a moving object; and
analyzing a physical size of each pixel by using the pixel distance and the coordinate distance.

17. A calibration apparatus comprising:
at least one memory comprising instructions and at least one hardware processor to execute the instructions within the at least one memory to implement:
acquiring a captured image from a capturing device for capturing a specified region including a plurality of markers;
determining a pixel distance corresponding to the number of pixels present between a first marker and a second marker of the plurality of markers;
determining a coordinate distance corresponding to a physical distance between the first marker and the second marker by using physical movement data from the first marker to the second marker of a moving object; and
analyzing a physical size of each pixel by using the pixel distance and the coordinate distance.
